(19) United States
(12) Patent Application Publication
(10) Pub. No.: US 2018/0103655 A1
(43) Pub. Date: Apr. 19, 2018

(54) Hard Candy with Gummy Center and Systems and Methods for Making Same

(71) Applicant: Ferrara Candy Company, Oakbrook Terrace, IL (US)

(72) Inventors: Arturo Hernandez Requejo, Linares (MX); Bertha Santiago Rodriguez, Linares (MX); Luis M. Escamilla, Lombard, IL (US); Ester Sussman, Chicago, IL (US); Vilairat Charoenwongse, Elmhurst, IL (US)

(21) Appl. No.: 15/297,075

(22) Filed: Oct. 18, 2016

(51) Int. Cl. A23G 3/54; A23P 30/20

(52) U.S. Cl. CPC A23G 3/545; A23V 2002/00; A23P 30/20

(57) ABSTRACT

An extrusion machine and method of use for making a multi-structure gummy candy. Specifically, the multi-structure candy provides a gummy center encapsulated by hard candy.

### BACKGROUND OF THE INVENTION

### 1. Field of the Invention

This disclosure is related to the field of candies and confectioneries and the manufacture thereof. Specifically, this disclosure relates to a multi-structure candy having a gummy center and a hard outer shell which is extruded.

### 2. Description of Related Art

Candy is generally any form of confection made using a sugar and/or sugar syrup as one of the primary ingredients. While the generally essential ingredient of a candy is some kind of sugar, many people actually consider candy to come in two general forms: chocolate and non-chocolate candies. Chocolate candies utilize chocolate in some manner, while other types of candies utilize sugars but do not include chocolate.

Chocolate candies are almost certainly the most popular form of candy, but non-chocolate candies have their own place and are still extremely popular. Within the realm of non-chocolate candies, one of the most popular are gel-based candies or more colloquially “gummies.” Gel-based candies have a long history. The earliest gel candy is likely something similar to Turkish Delight, the modern form of which is believed to have been developed in the late 1700's. However, when most people think of “gummies,” they more often think of candies akin to “Gummy Bears” or gelatin-based candies that are generally accepted as having been developed in the early 1900's by Hans Riegel of Bonn, Germany.

All gel-based candies obtain their consistency from the interaction of sugar and some form ofjellification agent. In most early gel candies, this was usually a starch, such as that from rice or corn, although pectin (heteropolysaccharide) is also known to have been used. Mr. Riegel, however, created a significantly different texture because he utilized sugar (and fruit flavors) in conjunction with gelatin. Candies utilizing gelatin as a jellification agent tend to have a much firmer texture and much more stretch and rebound than those using other jellification agents. In effect, they are more “rubbery.”

Gelatin-based candies are very popular in the modern world, and the gummy bear (and now the sour gummy worm) have an almost mythical place in the candy world. The same basic recipe and manufacturing techniques are used to sell a variety of flavors and shapes but ultimately all such gummies can be simplified to the same basic ingredients and manufacturing techniques; these ingredients and techniques have not changed significantly in their almost 100 years of existence. The ingredients have undergone little revision and include sugar, glucose syrup, starch, flavoring, food coloring, citric acid, and gelatin with some minor changes in percentages between different manufacturers and a possible inclusion of agents to provide for sour sensations. It is also important to note that gelatin from a variety of different animals (including, but not limited to, porcine and bovine gelatin) can be used to deal with various dietary restrictions. Further, in order to provide for vegetarian gummies, some modern gummies utilize starch or pectin and specific ingredients to mimic the structure of a gelatin-based candy without actually using gelatin.

Gelatin candies are also still formed, in many respects, in the same way they originally were. The liquid gelatin and sugar mixture (called a “gummy slurry”) is mixed at a relatively high temperature to produce a flowable liquid. The gummy slurry can be very sticky and will generally stick to most materials as it cools. This can make it near impossible to manufacture gummy candies in traditional molds. Instead, the gummy slurry is poured hot into a tray filled with cornstarch that is called a starch mogul. To generate the shape, the pattern of the gummy is stamped into the starch, making a negative mold before the gummy slurry is added. After the gelatin has set, the molds are turned out and the starch is generally recycled.

In modern manufacturing, the formed gummy candies are next placed in a panning machine where the candies receive a thin coating, generally of beeswax and/or carnauba wax, to give them their well-known shiny appearance and to inhibit them from sticking together in the bag. Stickiness is one of the major problems with gummy candies. Even with the coating, the candies will still readily stick together if exposed to heat. Some gummies are also coated with crystalized sugar to inhibit sticking.

Because of the popularity of candy, while old standbys will always be popular, there is a huge demand for new, and generally more intense, candy options. The relatively recent popularity of sour candies is one example. Another is the interest in multi-structure candies whereby candies of two radically different textures are combined in a single candy piece. While multi-structure candies are not new, with items such as Tootsie™ pops and Charm™ pops having been around for many years and items such as Jordan Almonds being traced back to the introduction of sugar cane to Europe, the stickiness and unique manufacturing requirements of gummy candies has made them particularly ill-suited for the modern candy making manufacturing techniques used for multi-structure candies.

Multi-structure candies are generally made by coating an existing candy or other substrate with a second type of candy. Most commonly (as is the case of Jordan Almonds), the underlying substrate (be it a candy, nut, or fruit piece) is coated by hard panning if one wishes to create a hard sugar shell. Enrobers and soft panning can also be used, but these will generally not create a crunchy shell. In hard panning, substrate pieces are placed in a draée pan and continuously sprayed with the coating mixture, which is slowly coated on the outer surface and hardens into a hard candy coating. Alternatively, the inner substrate may be added within a ribbon of hot hard candy, which is then rolled around it. The resultant candy rope can then be formed into spheres or other shapes by forming machines to encapsulate the center material. The formed structure can further be panned to clear up any imperfections and provide the final shape as well as any additional coating.

Gummy candies, however, generally cannot be combined with other candy types as they are unsuitable for the traditional production methods. In the first instance, as opposed to more traditional candy centers (such as, but not limited to caramel or bubble gum) gummy slurry is a true liquid before it jellifies, and then it is a gel. Gummy candy generally does not have a highly viscous intermediate or final stage like most other candies. Gummy candy also requires a specialty mold to form due to its stickiness. As such, generally gummy candies have to be made as distinct pieces and cannot readily be made as ropes or similar structures amenable to being coated with a hard candy shell in the manner in which soft center lollypops are made. Further, the forming of gummy spheres is generally extremely difficult, if not impossible.

To further complicate the problem, if gummy candies are individually formed, they then generally cannot be readily coated by hard panning techniques and especially since they cannot readily be made spherical, as is desirable for many coated candies. When exposed to even relatively modest heat, gummy candies will commonly get sticky and adhere to each other and to manufacturing machines, making it near impossible to coat them using traditional hard panning techniques which often utilize heated sprays and pans. Thus, it is noticeable that the vast majority of gummy candies are of a single texture. While soft panning is used to protect gummies in many cases, there are generally no hard coated gummies or any other type of multi-structure gummy candy.

### SUMMARY OF THE INVENTION

Because of these and other problems in the art, described herein, among other things is a multi-structure gummy candy. Specifically, the product provides a gummy center surrounded by a hard candy coating along with systems and methods for producing such a candy.

Described herein, among other things, is an embodiment of an extrusion head comprising: a distributing channel connected to an extrusion die; a feed pipe, said feed pipe being suspended in said distributing channel with a portion of said feed pipe arranged generally co-axial with said extrusion die; and a liquid head, said liquid head attached to a terminal end of said feed pipe and extending beyond said extrusion die; wherein said feed pipe is configured to transport a liquid from outside said distributing channel to said liquid head; wherein an extrudate in said distributing channel when extruded through said extrusion die around said liquid head forms a rope with a hollow interior volume; and wherein said liquid head injects said liquid into said hollow interior volume.

In an embodiment of the extrusion head, said extrudate includes sugar.

In an embodiment of the extrusion head, said sugar has been previously heated to hard crack stage.

In an embodiment of the extrusion head, said liquid includes sugar.

In an embodiment of the extrusion head, said liquid includes a jellification agent.

In an embodiment of the extrusion head, said jellification agent comprises gelatin.

In an embodiment of the extrusion head, said liquid is a gummy slurry.

In an embodiment of the extrusion head, said distribution channel is in the form of a funnel.

There is also described herein, in an embodiment, a multi-structure candy comprising: a gelatin-based gummy candy piece; a hard candy completely encapsulating said gelatin-based gummy candy piece; and a panned sugar shell surrounding said hard candy.

There is also described herein a method of making a multi-structure candy, the method comprising: extruding a candy mixture through an extrusion die and around a liquid head to form a rope with a hollow interior volume, said candy mixture having sugar previously heated to hard crack stage; injecting from said liquid head a liquid gummy slurry into said hollow interior volume of said rope; forming and cutting said rope into individual pieces while said gummy slurry is still liquid; cooling said individual pieces so as to form a multi-structure candy with a gummy candy completely encapsulated by a hard candy.

An embodiment of the method further comprises hard panning said multi-structure candy to put a sugar shell thereon.

### BRIEF DESCRIPTION OF THE DRAWINGS

FIGS. 1A, 1B, 1C, 1D, and 1E show five different views of an embodiment of a candy extrusion head modified to inject gummy slurry into a hollow candy rope.

FIG. 2 shows an embodiment of a connector pipe for connecting the feed pipe of the extrusion head to a gummy slurry feed tank.

FIGS. 3, 4, and 5 show various different views of an embodiment of an extrusion machine with a liquid injection head of a slightly different design to that of FIGS. 1A-RE, but with the same basic structure, in place.

FIG. 6 shows an embodiment of a candy rope being extruded.

FIG. 7 shows a flowchart of an embodiment of a process for making a hard coated gummy candy.

FIG. 8 shows a cut-through view of an embodiment of a multi-structure candy with a gummy center encapsulated by a hard candy shell.

### DETAILED DESCRIPTION OF PREFERRED EMBODIMENT(S)

Described herein are systems and methods for manufacturing a gummy candy surrounded or encapsulated by a hard candy shell. The techniques and systems discussed herein specifically contemplate a gelatin-based gummy candy, but the systems and methods can be amenable to use with candies formed using other jellification agents such as, but not limited to, starches and pectin. These systems utilize an extrusion head where a liquid injection head is used to inject a liquid inside an extrudate rope.

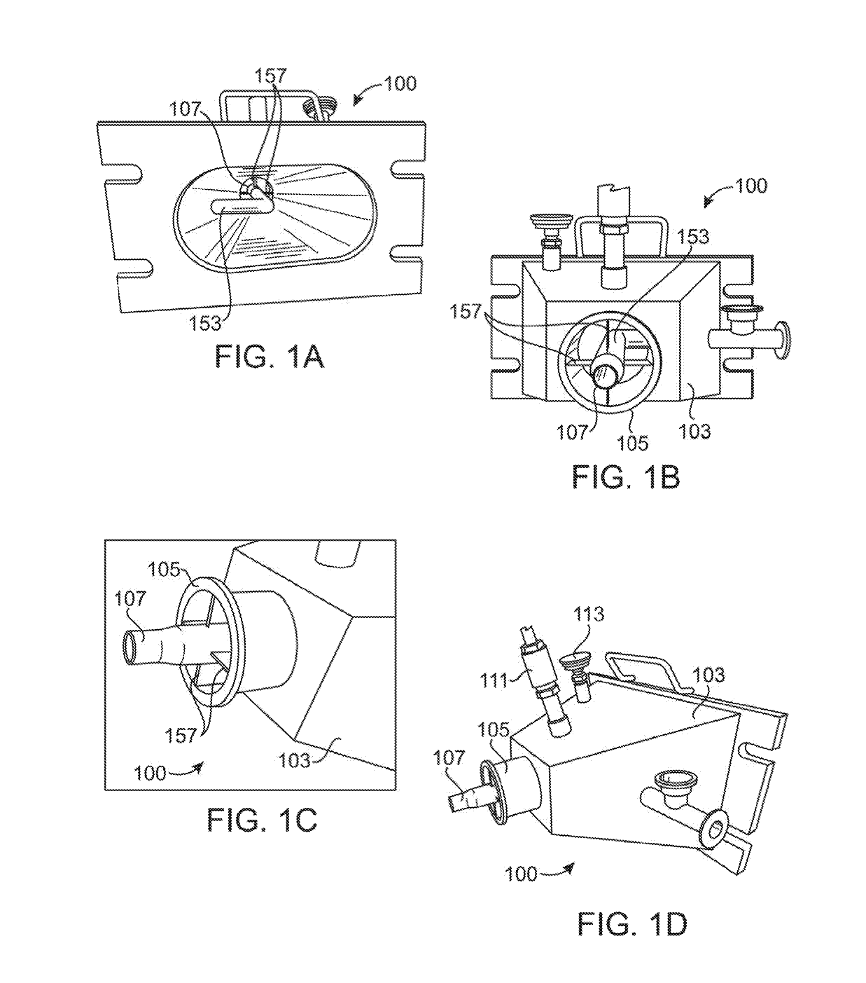

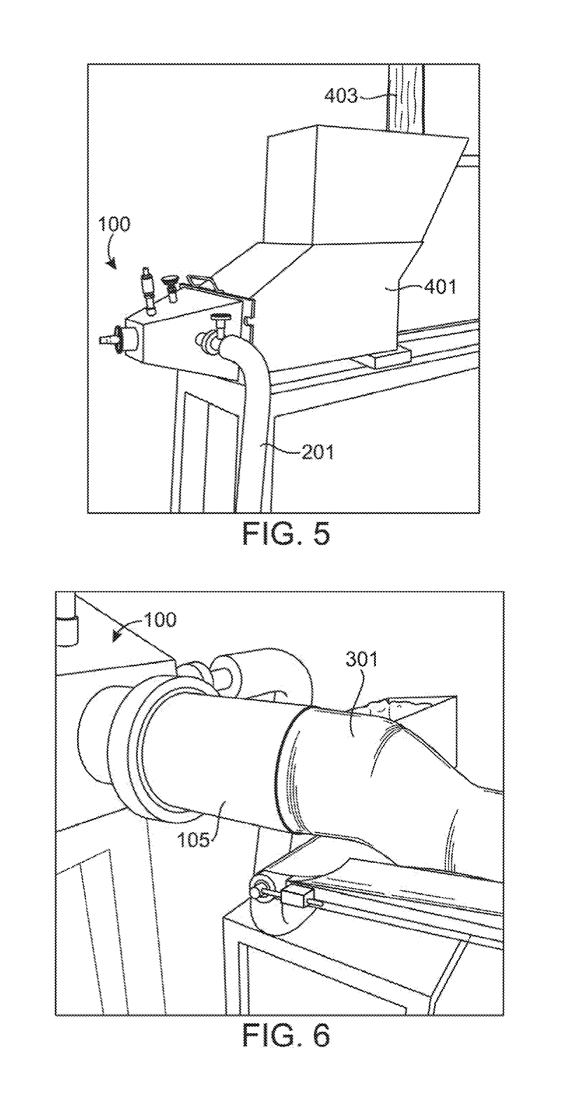

FIGS. 1A-1E provide various views of a first embodiment of an extruder head (100) suitable for use in extruding a hollow rope of a hard candy with a gummy slurry in the hollow interior volume. The extruder head (100) comprises a standard distribution channel which, in the depicted embodiment, is funnel section (103) which leads to the extrusion die (105). As the candy rope (301) (as visible in FIG. 6) in this particular embodiment is intended to be cylindrical, the extrusion die (105) is circular. As would be recognized by one of ordinary skill in the art, different die shapes (including ovals, triangles, squares, etc.) will yield different shapes of candies. Mounted at a generally centered position in the extrusion die (105) and co-axial with the injection die (105) and resultant rope (301) is a liquid injection head (107). The liquid injection head (107) will generally extend about 4 to about 5 inches in front of the extrusion die (105) and will preferably be in the shape of a tapered cylinder reducing from about % in diameter to about ½ inch in diameter along its length. With this arrangement, the liquid injection head (107) will extend into the hard candy rope (301) which is produced by the injection head (100).

The liquid injection head (107) is held in place in the extrusion die (105) via at least one, and generally a plurality of thin wings (157). The wings (157) are generally designed to be thin, at least in the direction parallel to the direction that the rope exits the extrusion die (105). While the exact shape and size of the wings (157) is variable, they are preferably thin as they will cut the rope (301) as it is being formed, and it is desirable that the formed cut self-seal quickly due to the structure, viscosity, and inherent stickiness of the hard candy mixture immediately after the rope has left the extrusion die (105). The wings (157) may be considered comparable to spider legs known in the art of plastic extrusion for allowing multiple extradite streams to be combined.

The liquid injection head (107) is generally located on the terminal end of a generally “L” shaped feed pipe (153) which first extends backwards into the injection funnel (103) and then turns to exit a side of the funnel (103) as is best visible in FIGS. 1A and 1E. The location that the feed pipe (153) exits the funnel (103) may correspond with the standard location of a dye injection in many hard candy extrusion heads, but this is by no means required and the feed pipe (153) may exit on any side in any position.

Further, the feed pipe (153) need not have a single generally 90 degree turn as shown in the embodiment of FIGS. 1A-1E; rather, the feed pipe (153) may include one or multiple bends of any angle at any position. It is simply desired that the feed pipe (153) exit the funnel (103) at a distance back from the extrusion head (105). In this way, the hard candy material can pass over the portion of the feed pipe (153) which is not generally parallel and coaxial with the extrusion die (105) without the feed pipe (153) interfering with the extrusion of the hard candy material through the extrusion die (105).

In order to monitor process conditions, it is preferred but not necessary that the funnel (103) has placed therein a variety of sensors. These sensors are used to monitor the hard candy mixture and/or the gummy slurry to make sure it is maintained at appropriate operating parameters. In the depiction of FIGS. 1A-1E, the funnel (103) includes a manometer (111) and a thermometer (113) to measure pressure and temperature respectively. These will generally be the most important characteristics of the hard candy mixture to measure. The pressure of extrusion is necessary to make sure that the hard candy mixture is extruding in a consistent fashion so as to make the necessary walls for the gummy slurry and the temperature is necessary to make sure that the hard candy mixture does not prematurely solidify or become too thin. Together, the temperature and pressure staying in desired parameters allows for the candy rope (301) to support the gummy slurry.

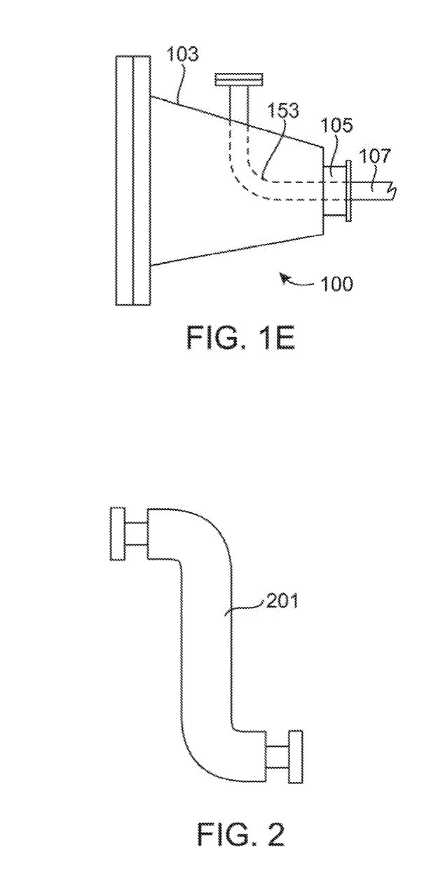

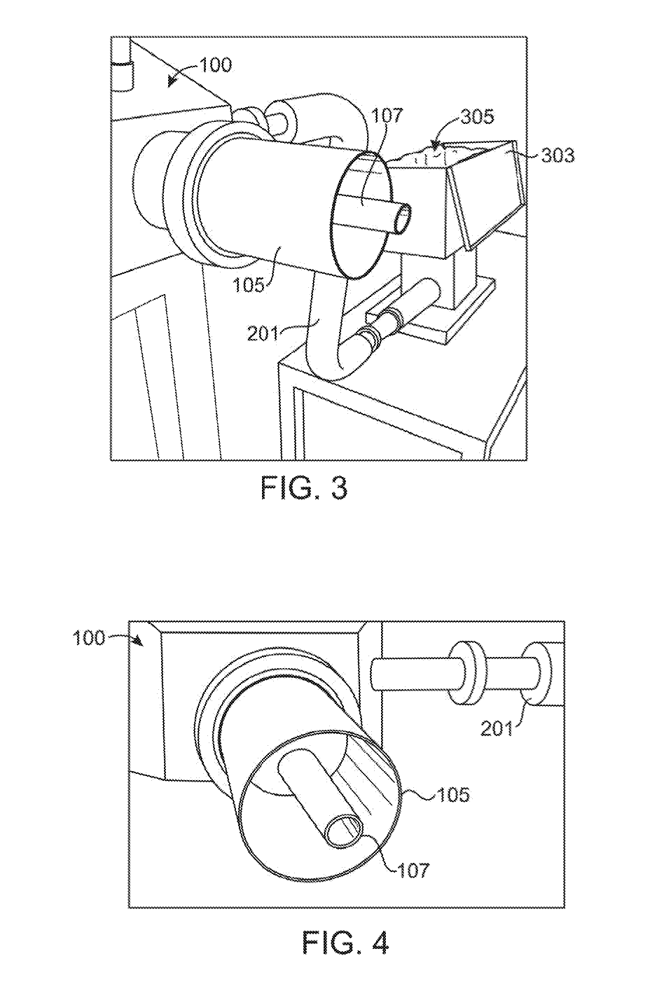

To provide gummy slurry to the extrusion head, the slurry will generally be provided in a tank such as tank (303) shown in FIG. 3. This can be an existing, but repurposed, tank (303) which already exists to combine liquids with the extrusion mixture in the funnel (103) or may be a specifically designed tank (303). The liquid from the tank (303), in the depicted embodiment, is carried via an S curved pipe (201) as shown in FIG. 2 which interconnects an outlet of the tank (303) to the feed pipe (153). The slurry may be moved from the tank (303) by pumping, the application of pressure, or any other means or method known to one of ordinary skill in the art to move a liquid from the tank (303) to the feed pipe (153).

It is important to recognize that the liquid in the feed pipe (153) and being injected through the liquid head (107) in an embodiment is generally not under pressure. The liquid leaving the head (107) is not forced out but is essentially freely flowing. This can be by having the feed pipe (153) configured with a slightly downward tilt so that liquid, upon entering the feed pipe (153), is pulled toward the head (107) simply by the force of gravity, or by selecting a pressure, pump speed, or related parameter which results in the flow into the feed pipe (153) being essentially neutral. That is, the same amount of liquid is added to the feed pipe (153) in any given time window as leaves the feed pipe (153) in the same window. Preferably, if there were no hard candy rope present, the liquid will essentially flow from the end of the liquid head (107) and turn downward under the force of gravity.

As a point of further clarification, it should be recognized that an extrudate can be technically defined as a liquid under some definitions of liquid. However, in the present case, the liquid being injected is not an extrudate while the hard candy mixture clearly is. As contemplated above, the liquid being injected is characterized as a liquid in this disclosure because it is freely flowing and therefore moves internally within the candy rope (301) after it has been injected if there is sufficient space for it to move. The candy rope (301), however, is an extrudate as it is pushed through the extrusion die in a standard fashion. Thus, the present disclosure in no way contemplates a co-extrusion methodology, where one extrudate is extruded over another, but instead contemplates the injection of liquid into a hollow extrudate rope using a head (100), such as that contemplated above.

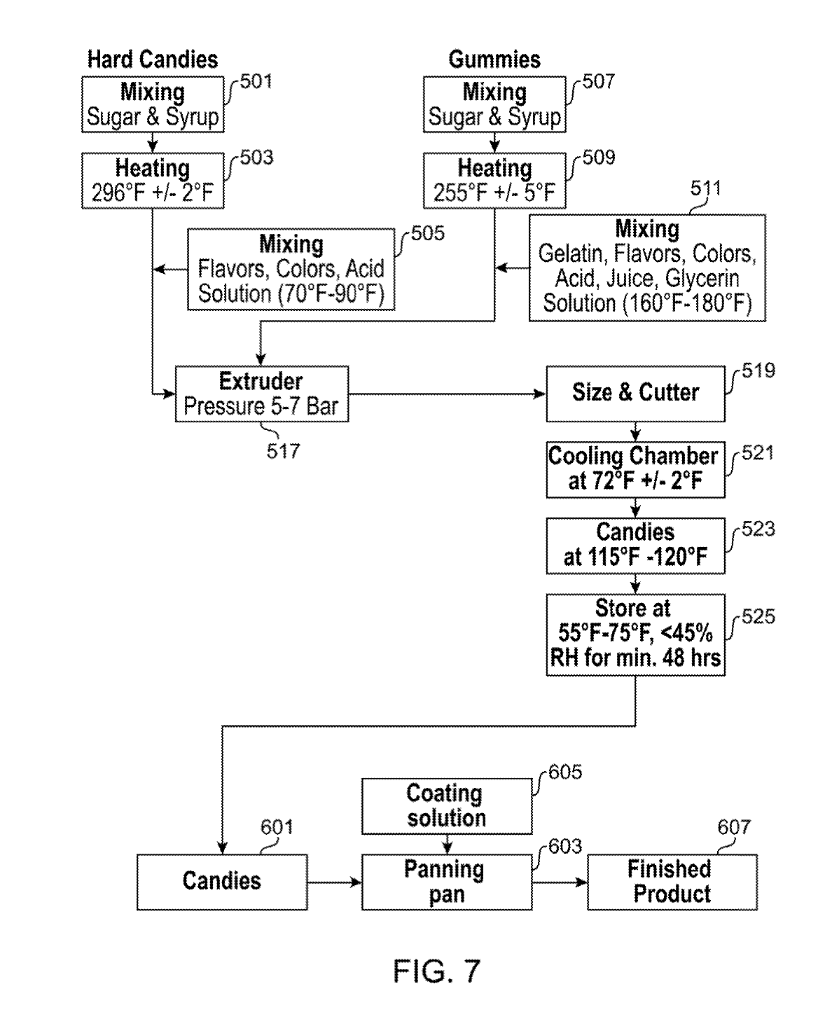

FIG. 7 provides an embodiment of the operation of a candy manufacturing process for making a multi-structure candy with a gummy center encapsulated by a hard candy shell. The process of FIG. 7 is best discussed in conjunction with the various extruder images shown in FIGS. 3 through 6.

First, the hard candy mixture (401) is formed by mixing the sugar and syrup (and also commonly water) together at a location spaced from the extruder as contemplated in step (501). The hard candy mixture (401) is then typically heated to hard crack stage (between about 209 to about 295 degrees Fahrenheit) at step (503). After reaching hard crack stage, the mixture (401) is cooled, and additional flavors and colors may be added in a further mixing step (505) to avoid damage to these ingredients from the prior high heat. At this stage, the hard candy mixture (401) is beginning to become very viscous with sufficient plasticity to be extruded as an extrudate as best shown in FIG. 5. The hard candy mixture (401) is then fed into an extrusion hopper (403), which is connected to the wide end of the funnel (103) of the extrusion head (100). The temperature and pressure of the hard candy mixture (401) in the hopper (403) and extrusion head (100) will be controlled and maintained at generally about 70 to about 90 degrees Fahrenheit and about 5 to about 7 bar, respectively.

While the hard candy mixture (401) is being prepared, the gummy slurry (305) will generally also be being prepared. In the gummy slurry (305), the sugar, syrup, and water are also mixed in step (507). The mixture is then heated (509). For the slurry (305), a hard crack temperature is not used and a hard ball temperature (about 250 to about 266 degrees Fahrenheit) is preferably used. However, this temperature is somewhat dependent on the type of gummy slurry (305) to be formed and the gelling agent used. The gummy slurry (305) will also generally be allowed to cool before the additional mixing in step (511) of remaining ingredients including the jellification agent, but will generally be much hotter than the hard candy mixture (about 160 to about 180 degrees Fahrenheit) when provided to the extruder. The gummy slurry (305) is then sent to the tank (303) and is fed into the S pipe (201) and then the feed pipe (153) and liquid injection head (107).

Pressure from behind the funnel (103) will force the hard candy mixture (401) toward the extrusion die (105), where it will be formed into a rope (301) as can be best seen in FIG. 6, using standard extrusion techniques known to those of ordinary skill in the art. Because of the position of one leg of the L of the feed pipe (153) being generally coaxial with the rope (301) as it passes through the extrusion die (105), the hard candy mixture (401) generally cannot form a center and the rope (301) will be formed hollow. The remaining portion of the feed pipe (153) is generally too far back in the funnel (103) to affect the extrusion, and therefore the hard candy mixture (401) simply flows around it due to the pressure. The mixture will also flow over the wings (157) as it exits the extrusion die (105), with each wing making a slight cut in the rope (301) parallel to its major axis. However, as the wings (157) are thin, the opposing sides of the cut will quickly stick together, forming a solid wall as can be seen in FIG. 6.

As the rope (301) exits the extrusion die (105), it is thus in the form of a hollow cylinder. The extension of the liquid head (107) beyond the extrusion die (105) serves to help maintain the hollow shape by inhibiting the two opposing “sides” (the top and bottom) of the rope from contacting each other due to the force of gravity for a period of inches (generally around 4 to 5 inches) from the extrusion die (105). The hard candy rope (301) will quickly begin to solidify as soon as it leaves the extrusion die (105) as the ambient temperature will generally be below that inside the funnel (103).

As the rope (301) progresses, the liquid head (107) will be dispensing the gummy slurry (305) into the hollow center of the rope (301) four to five inches downstream of the rope (301) exiting the extrusion die (105). This gives the rope (301) a distance of about four to five inches from the small cuts caused by the wings (157) to reconnect and for the hard candy rope (301) to begin to cool and solidify. As the gummy slurry (305) is a free flowing liquid, the gummy slurry (305) will flow to the end of the formed rope (301) and immediately fill the hollow interior of the rope (301). So long as the gummy slurry (305) is allowed to freely flow (no pressure applied to force it into the rope (301)) and the flow is sufficient, the hollow interior of the rope (301) will fill with gummy slurry (305).

There are several elements which are important in the operation of the extrusion head (100) to make sure that the gummy slurry (305) is maintained in the rope (301). In the first instance, as discussed above, the gummy slurry (305) needs to be a free flowing liquid when it is injected. As the liquid is substantially less viscous than the hard candy mixture (401), it does not behave like an extruded plastic, but behaves as a traditional liquid. This means it can freely flow within the hollow interior of the rope (301) as opposed to what would traditionally happen if it was coextruded. Further, the liquid will generally be greatly influenced by the force of gravity and will generally flow downhill after it is injected.

The gummy slurry (305) is injected inside of the hard candy rope (301), as shown in step (517). As can be best seen in FIG. 6, the rope (301) is generally directed downward after it leaves the extrusion die (105) and thus the gummy slurry (305) will generally flow toward the far end of the rope (301) from the extrusion head (100), resulting in the distal end of the rope (301) being the most filled. Because of the downhill flow of the candy rope (301), the flow of liquid into the rope at the liquid injection head (107), even if less than sufficient to actually fill the hollow interior at the time of extrusion, can be sufficient to fill the hollow interior when the rope (301) is cut into individual pieces. The introduction of the rope (301) into later sizing machines, which will reduce the volume of the hollow interior, will generally result in the gummy slurry (305) flowing back toward the liquid head (107) within the hollow interior as the size of the hollow interior is reduced. Thus, the hollow interior at the commencement of sizing and cutting in step (519) will generally be completely filled with liquid both from the injection head (107) and from any back flow coming backward from the forming and sizing machines.

The presence of the gummy slurry (305) in the hollow interior of the rope (301), will generally also create a small amount of pressure to inhibit the opposing sides of the rope (301) from moving toward each other after the rope (301) has cleared the liquid head (107). However, should the hollow interior collapse somewhat due to the mass of the upper wall of the rope (301), this is not a problem, so long as opposing interior “sides” of the hard candy rope (301) do not touch and close off the hollow interior volume.

Should there be an instance where pressure begins to build up in the liquid in the rope (301), there can be a scenario where the wall of hard candy rope (301) could rupture. However, if pressure does start to form, the liquid gummy slurry (305) will generally create a backpressure back into the liquid head (107), which will generally temporarily halt the flow of the liquid from the tank (303) through the liquid head (107). This will result in a pressure decrease within the hollow candy rope (301) and the situation will be eliminated.

As shown in FIG. 6, the gummy slurry (305) is not visible as it is internal to the visible rope (301). This rope (301) is then carried away from the extrusion die (105) generally using a conveyor as is known to those of ordinary skill in the art. At this stage, the hollow rope (301) is generally filled with the liquid gummy slurry, which has not begun to solidify in any substantial respect.

Downstream of the conveyor, the rope (301) can be fed through forming wheels and related structures which serve to decrease the diameter of the rope in step (519). This is a standard process known to those in the candy making arts and there is no need to discuss it here, as such forming can occur in any known fashion. Further downstream, the rope (301) will be cut into individual pieces as also contemplated in step (519). So long as appropriate cutting machines are used, the rope (301) can be cut in a way where the hollow interior does not have communication with the ambient surrounding air during the cutting process. As a simple example, the rope (301) can first be pinched together, and then the cut can be made through the pinch. Using any appropriate cutting technique, the liquid gummy slurry (305) cannot flow out of the hollow interior as the rope (301) is cut into individual pieces. Thus, there are now formed individual candy pieces, each of which has a hollow interior substantially filled with liquid gummy slurry (305) at the completion of step (519).

These individual candy pieces are then sent to cool in step (521) and for the gummy slurry (305) to form into a gel. As the gummy slurry (305) jellifies, the gummy slurry (305) will generally release water due to evaporation. As opposed to traditional gummy candy manufacture, this cannot directly escape to the air. Thus, the water percentage in the gummy slurry (305) is generally carefully chosen and is generally less than that for a traditional gummy candy as indicated in the example below. In this way, a greater percentage of the available water in the gummy slurry (305) is utilized by the jellification and is not evaporated. However, the percentage which does evaporate will generally evaporate into the hard candy structure encapsulating it, which also includes water evaporating as the hard candy structure itself cools. As the gummy slurry (305) and hard candy (301) shell will behave as a unit, so long as there is not too much water added via the gummy slurry (305), the water transitioning from the gummy slurry (305) to the hard candy (301) shell may slow the crystallization of the hard candy (301) shell, but will generally not result in damage to the shell or modification of its structure.

As can be seen in FIG. 7, the cooling will generally comprise two stages. The first cooling stage (523) generally reduces the temperature of the candies to about 115-120 Fahrenheit. Once the candies have reached this stage, they are sufficiently cooled to be stable. They may then be stored in step (525) until their relative humidity reaches a desired level. This will commonly be less than 45% and that level will need to be maintained for a period of time (e.g., 48 hours or more) to ensure that the candies have fully formed and evaporation of water has ceased.

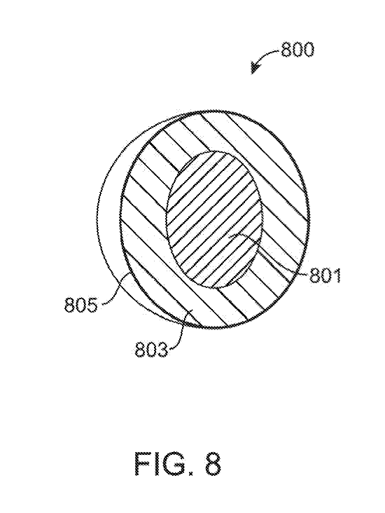

Once the candies have sufficiently cooled in step (525), they are essentially complete, having formed the gummy center within the hard candy shell which has now solidified. As should be apparent, the candies are multi-structure candies (800), such as the core of those shown by way of example in FIG. 8. However, to provide still further refinement, the candy pieces (601) may now be transferred to a panning machine as contemplated in step (603). As should be apparent, the candies now provided to panning will behave as a solid hard candy. Thus, they can be panned in the same way as a traditional hard candy as the gummy center cannot contact the sprayed sugar solution or the panning machine as it is completely encapsulated by the hard candy shell. The coating solution (605) may be anything, but will preferably be a hard sugar coating, which will serve to both reinforce the outer structure as well as to make the outer wall thicker or to provide a third layer of different texture and hardness. It also allows for the resulting candy to have multiple colors, as the gummy slurry, hard candy rope, and panned coating can each be any color, or even multiple colors.

Panning is performed in a traditional fashion by adding a coating solution to a panning pan to produce a finished product. Once panning is completed, the candies are completely finished in step (607) and may be allowed to cool from the panning process. They may then be packaged in a traditional fashion. The resultant candies may be of any size, but to enhance the multi-structure experience will commonly be larger around 2 centimeters in diameter to allow them to be both sucked and broken with the teeth at different times during consumption. FIG. 8 shows an embodiment of the resultant candy that has been cut in half to show the different structures. Specifically, there is visible a gummy center (801) encapsulated by the hard candy (803). There is then a very thin surface shell (805) from the panning process.

It should be recognized that, while the above produces a particulate candy, the candy can also be formed with a stick to produce a lollipop. The stick can be added at any stage but will generally be added after the individual pieces are formed, but before cooling. Further, while panning is contemplated to add a sugar shell, which can add additional structure, smoothness, and/or color, other known techniques can be applied to the candy after step (525). In particular, the candy may be supplied to an enrober for a soft coating such as chocolate.

While the above has discussed the general systems and methods for forming a candy with a gummy center and a hard candy coating such as that shown in FIG. 8, the below Example provides some specifics of an embodiment of forming a specific candy. This candy has a gelatin-based gummy center with a hard candy coating that is then further coated with a panned shell.

### EXAMPLE

The candy of this example has a gelatin-based gummy center with a hard candy coating that is then further coated with a panned sugar shell to improve appearance.

The gummy slurry is formed from the ingredients of Table 1.

TABLE 1
Gummy Slurry

| Ingredients | % Range |
|---|---|
| Sugar | 25-30 |
| Glucose Syrup | 50-55 |
| Gelatin | 5-10 |
| Sodium Citrate | 03-0.5 |
| Fruit Juice Concentrate | 0.2-0.4 |
| Citric Acid | 1.5-1.8 |
| Flavors | 2-5 |
| Glycerin | 1-2 |
| Colors | 0.003-0.005 |
| Water | 15-20 |

The sugar, water, and syrup in the gummy slurry will generally be heated to between about 250 and about 260 degrees Fahrenheit in the initial mixing step. The remaining ingredients will be added when the sugar and syrup mixture has cooled to between about 160 and about 180 degrees Fahrenheit and the gummy slurry will be injected into the candy rope at between about 160 to about 170 degrees Fahrenheit with a density of about 1.18 to about 1.22 g/ml.

The hard candy is formed from the ingredients in Table 2.

TABLE 2
Hard Candy

| Ingredients | % Range |
|---|---|
| Water | 10-14 |
| Sugar | 40-44 |
| Glucose Syrup | 50-54 |
| Citric Acid | 0.5-0.8 |
| Flavors | 0.1-0.4 |
| Colors | 0.002-0.004 |

The sugar, water, and syrup in the hard candy mixture will generally be heated to between about 294 and about 298 degrees Fahrenheit in the initial mixing step. The remaining ingredients will be added when the sugar and syrup mixture has cooled to between about 70 and about 90 degrees Fahrenheit, resulting in the hard candy mixture being a highly viscous mixture with good plasticity. The hard candy will be extruded at about the same temperature it was cooled to and at a pressure of about 5 to about 7 bar.

Panning is performed according to industry standard practices using traditional machines and processes. The coating for the panning is provided in Table 3.

TABLE 3
Panning Coating

| Ingredients | % Range |
|---|---|
| Arabic Gum | 1-1.2 |
| Citric Acid | 9-10 |
| Malic Acid | 9-10 |
| Sodium Citrate | 1.6-1.8 |
| Sugar | 80-82 |

Upon completion of the final candy product, the candy of this example has the composition of Table 4.

TABLE 4
Final Candy Composition

| Components | % Range |
|---|---|
| Gummi | 12-18 |
| Hard Candy | 74-78 |
| Coating | 14-18 |

While the invention has been disclosed in connection with certain preferred embodiments, this should not be taken as a limitation to all of the provided details. Modifications and variations of the described embodiments may be made without departing from the spirit and scope of the invention, and other embodiments should be understood to be encompassed in the present disclosure as would be understood by those of ordinary skill in the art.

1. An extrusion head comprising:
a distributing channel connected to an extrusion die;
a feed pipe, said feed pipe being suspended in said distributing channel with a portion of said feed pipe arranged generally co-axial with said extrusion die; and
a liquid head, said liquid head attached to a terminal end of said feed pipe and extending beyond said extrusion die;
wherein said feed pipe is configured to transport a liquid from outside said distributing channel to said liquid head;
wherein, when extruded through said extrusion die around said liquid head, an extrudate in said distributing channel forms a rope with a hollow interior volume; and
wherein said liquid head injects said liquid into said hollow interior volume.

2. The extrusion head of claim 1 wherein said extrudate includes sugar.

3. The extrusion head of claim 2 wherein, prior to extrusion, said sugar has been heated to hard crack stage.

4. The extrusion head of claim 1 wherein said liquid includes sugar.

5. The extrusion head of claim 4 wherein said liquid includes a jellification agent.

6. The extrusion head of claim 5 wherein said jellification agent comprises gelatin.

7. The extrusion head of claim 5 wherein said liquid is a gummy slurry.

8. The extrusion head of claim 1 wherein said distribution channel is in the form of a funnel.

9. A multi-structure candy comprising:
a gelatin-based gummy candy piece;
a hard candy completely encapsulating said gelatin-based gummy candy piece; and
a panned sugar shell surrounding said hard candy.

10. A method of making a multi-structure candy, the method comprising:
extruding a candy mixture through an extrusion die and around a liquid head to form a rope with a hollow interior volume, said candy mixture having sugar previously heated to hard crack stage;
injecting from said liquid head a liquid gummy slurry into said hollow interior volume of said rope;
forming and cutting said rope into individual pieces while said gummy slurry is still liquid; and
cooling said individual pieces so as to form a multi-structure candy with a gummy candy completely encapsulated by a hard candy.

11. The method of claim 10 further comprising:
hard panning said multi-structure candy to put a sugar shell thereon.
